(19) United States
(12) Patent Application Publication
(10) Pub. No.: US 2025/0350393 A1
(43) Pub. Date: Nov. 13, 2025

(54) OPTICAL PATH DESIGN APPARATUS, OPTICAL PATH DESIGN METHOD AND PROGRAM

(71) Applicant: NIPPON TELEGRAPH AND TELEPHONE CORPORATION, Tokyo (JP)

(72) Inventors: Takafumi TANAKA, Musashino-shi (JP); Katsuaki HIGASHIMORI, Musashino-shi (JP)

(73) Assignee: NIPPON TELEGRAPH AND TELEPHONE CORPORATION, Tokyo (JP)

(21) Appl. No.: 18/871,738

(22) PCT Filed: Jun. 8, 2022
(86) PCT No.: PCT/JP2022/023090

§ 371 Date: Dec. 4, 2024

(51) Int. Cl. H04J 14/02

(52) U.S. Cl. CPC H04J 14/0227

(57) ABSTRACT

The demand acquisition unit acquires the path demand indicating a start point and an end point of communication and a required communication capacity. The graph generation unit generates an auxiliary graph in which a plurality of nodes are connected by an existing edge and a new edge. In the auxiliary graph, the transmission scheme and the frequency of the wavelength path and the weight are set for each edge. The search unit searches for a route indicated by the path demand for the auxiliary graph on the basis of the weight. The design unit sets a wavelength path in the optical communication path by the transmission scheme related to the new edge included in the searched route, and accommodates the path demand in the wavelength path at a frequency related to each edge included in the route.

### TECHNICAL FIELD

The present invention relates to an optical path design device, an optical path design method, and a program.

### BACKGROUND ART

There is known a multilayer network including a wavelength division multiplexing (WDM) path in which one or more wavelengths are multiplexed and transmitted through an optical fiber, and one or more time division multiplexing (TDM) paths accommodated in each wavelength division multiplexing path, the one or more TDM paths having a fixed length of time slot as a unit. When a multilayer path demand is generated in such a multilayer network, it is necessary to accommodate the multilayer path demand by determining a route and a frequency of a wavelength division multiplexing path, and a route of a time division multiplexing path.

Non Patent Literature 1 discloses a method for performing multilayer path accommodation design using an auxiliary graph. Non Patent Literature 1 discloses that, when a multilayer path demand between two points is generated, an appropriate route and an appropriate frequency can be selected by searching for the shortest route in an auxiliary graph in which an edge configured with an existing wavelength division multiplexing path capable of accommodating the demand and an edge configured with a new path are synthesized.

### CITATION LIST

### Non Patent Document

Non Patent Document 1: Shuqiang Zhang, Charles Martel, Biswanath Mukherjee, “Dynamic traffic grooming in elastic optical networks”, IEEE Journal on selected areas in communications, vol. 31, no. 1. January 2013.

### SUMMARY OF INVENTION

### Technical Problem

On the other hand, in recent years, with the progress of digital coherent optical communication technology, a modulation scheme, a symbol rate, and the like can be arbitrarily set by a single device, and thus, design becomes more complicated. In a digital coherent optical transceiver, a modulation scheme, a symbol rate, and the like are generally selected from transmission modes that are combinations thereof in order to facilitate state management. For example, in a case where QPSK and 16 QAM can be used as modulation schemes and each has two types of bit rates, there are four transmission modes. An actual transmission mode may include more combinations.

However, a method for determining a transmission mode simultaneously with a route or a frequency of a multilayer path has not been proposed. In a case where the transmission mode is designed separately from the route and the frequency, the range of possible solutions may be narrowed, and an outputted solution may deviate from the optimal solution. Non Patent Literature 1 also does not disclose a method for selecting the best mode from a large number of transmission modes.

An object of the present invention is to provide an optical path design device, an optical path design method, and a program that can determine a transmission mode simultaneously with a route in an optical network including a wavelength division multiplexing path having a large number of transmission modes.

### Solution to Problem

An aspect of the present invention is an optical path design device for designing a path on the basis of a path demand in an optical network including an optical communication path in which one or more time-divided wavelength paths are set, the optical path design device including: a demand acquisition unit configured to acquire the path demand indicating a start point and an end point of communication and a required communication capacity; a graph generation unit configured to generate an auxiliary graph, in which a plurality of nodes making up the optical network is connected by an existing edge that is an edge indicating a wavelength path to which the path demand can be allocated among wavelength paths set in the optical communication path and a new edge that is an edge indicating a candidate of a wavelength path that can be newly set, and in which a transmission scheme and a frequency of a wavelength path and a weight of an edge are set for each edge; a search unit configured to search for a route from a start point to an end point indicated by the path demand for the auxiliary graph on the basis of the weight; and a design unit configured to generate path design information for setting a wavelength path in the optical communication path by the transmission scheme related to the new edge included in the searched route, and for accommodating the path demand in the wavelength path at a frequency related to each edge included in the route.

An aspect of the present invention is an optical path design method for designing a path on the basis of a path demand in an optical network including an optical communication path in which one or more wavelength division multiplexing paths are set, the optical path design method including: a demand acquisition step of acquiring the path demand indicating a start point and an end point of communication and a required communication capacity; an auxiliary graph generation step of generating an auxiliary graph connecting a plurality of nodes making up the optical network by an existing edge that is an edge indicating a wavelength division multiplexing path to which the path demand can be allocated among wavelength division multiplexing paths set in the optical communication path and a new edge that is an edge indicating a candidate of a wavelength division multiplexing path that can be newly set; an edge setting step of setting a transmission mode of the wavelength division multiplexing path indicated by an edge, a frequency to which the path demand is allocated, and a weight for each edge of the auxiliary graph; a search step of searching for a route from a start point to an end point indicated by the path demand for the auxiliary graph on the basis of the weight; and a design step of generating path design information for setting a wavelength division multiplexing path in the optical communication path in the transmission mode related to the new edge included in the searched route and allocating the path demand to the wavelength division multiplexing path at a frequency related to each edge included in the route.

An aspect of the present invention is a program for causing a computer to function as the optical path design device according to the above aspect.

### Advantageous Effects of Invention

According to the above aspects, it is possible to determine a transmission mode simultaneously with a route in an optical network including a wavelength division multiplexing path having a large number of transmission modes.

### BRIEF DESCRIPTION OF DRAWINGS

FIG. 1 A diagram illustrating an optical path design device and a multilayer network NW according to an embodiment.

FIG. 2 A diagram illustrating an example of a method of accommodating a multilayer path demand in an embodiment.

FIG. 3 A schematic block diagram illustrating a configuration of an optical path design device according to a first embodiment.

FIG. 4 A flowchart illustrating a multilayer path design method according to the first embodiment.

FIG. 5 A flowchart illustrating a method of generating an existing graph according to the first embodiment.

FIG. 6 A flowchart illustrating a method of generating a new graph according to the first embodiment.

FIG. 7 A diagram illustrating an example of a configuration of a physical network according to the first embodiment.

FIG. 8 A diagram illustrating an example of an existing graph according to the first embodiment.

FIG. 9 A diagram illustrating an example of a new graph according to the first embodiment.

FIG. 10 A diagram illustrating an example of an auxiliary graph according to the first embodiment.

FIG. 11 A diagram illustrating a route search result according to the first embodiment.

FIG. 12 A schematic block diagram illustrating a configuration of an optical path design device according to a second embodiment.

### DESCRIPTION OF EMBODIMENTS

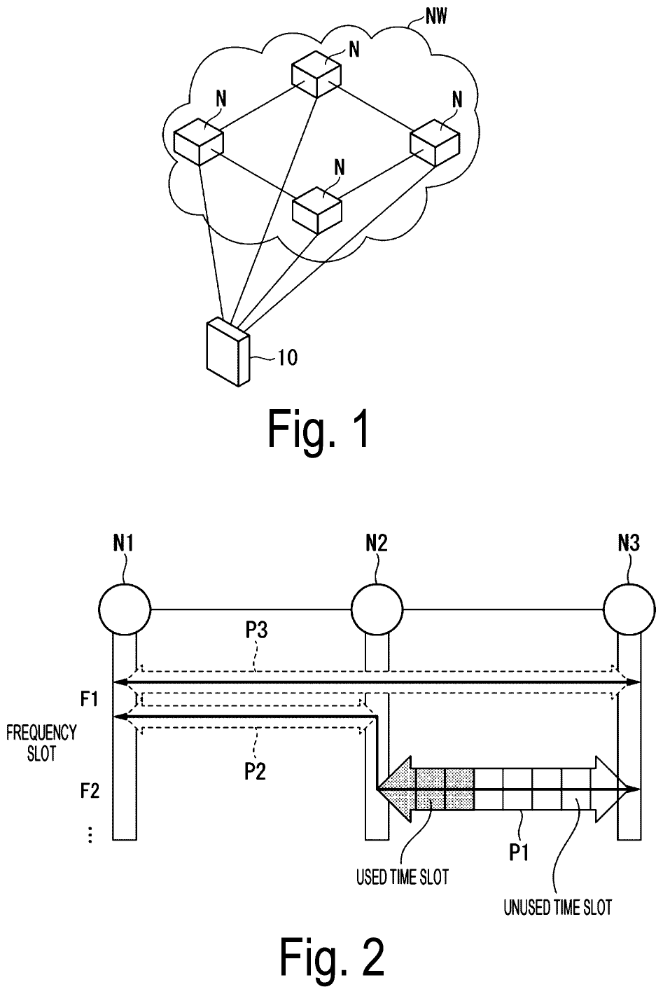

Embodiments of an optical path design device, an optical path design method, and a program will be described below. FIG. 1 is a diagram illustrating an optical path design device 10 and a multilayer network NW according to an embodiment. When a new multilayer path demand (connection request) is generated in the multilayer network NW, the optical path design device 10 according to an embodiment designs a multilayer path accommodating the multilayer path demand.

The multilayer network NW is a network in which a plurality of nodes N are connected by optical communication paths such as optical fibers. Each node N may be a digital coherent optical transceiver. Each node N sets a wavelength division multiplexing path for multiplexing optical signals having one or more wavelengths between the node N and a node facing the node N. The wavelength division multiplexing path is a path in which one or more wavelength paths are multiplexed. The wavelength path is allocated to a frequency band including a partial frequency slot group among a plurality of frequency slots obtained by dividing a frequency band that can be used in the optical communication path. The frequency bandwidth of the wavelength path is determined by a modulation scheme and a bit rate. The combination of the modulation scheme and the symbol rate of a signal that can be set in the wavelength division multiplexing path is prepared in advance as the transmission mode. The modulation scheme, the symbol rate, and the transmission mode are examples of the transmission scheme.

In the multilayer network NW, a wavelength division multiplexing path is time-divisionally multiplexed into a plurality of time slots. That is, the multilayer network NW includes an optical communication path in which one or more time-divided wavelength paths are set. A combination of a wavelength path and a time slot is allocated to the multilayer path demand.

Here, accommodation of the multilayer path demand will be described. FIG. 2 is a diagram illustrating an example of a method of accommodating a multilayer path demand in an embodiment.

In the example illustrated in FIG. 2, the multilayer network NW has the following configuration. The multilayer network NW includes a node N1, a node N2, and a node N3. The node N1 and the node N2 are connected via an optical communication path, and the node N2 and the node N3 are connected via an optical communication path. A wavelength path P1 that uses a frequency slot F2 is set between the node N2 and the node N3.

Here, in a case where a multilayer path demand having the node N1 as a start point and the node N3 as an end point is generated, it is conceivable that the multilayer path demand is accommodated as follows.

A first accommodation method is to set a new wavelength path P2 having a hop count of 1 using a frequency slot F1 between the node N1 and the node N2, and accommodate the multilayer path demand in an arbitrary time slot of the new wavelength path P2 and an unused time slot of the existing wavelength path P1. In this case, electrical relay processing is performed at the node N2.

A second accommodation method is to set a new wavelength path P3 having a hop count of 2 using the frequency slot F1 between the node N1 and the node N3, and accommodate a multilayer path demand in an arbitrary time slot of the new wavelength path P3. In this case, the node N2 transfers an optical signal inputted from the node N1 to the node N3 without performing photoelectric conversion.

When a multilayer path demand is generated, the optical path design device 10 according to an embodiment designs a route that appropriately accommodates the multilayer path demand.

### First Embodiment

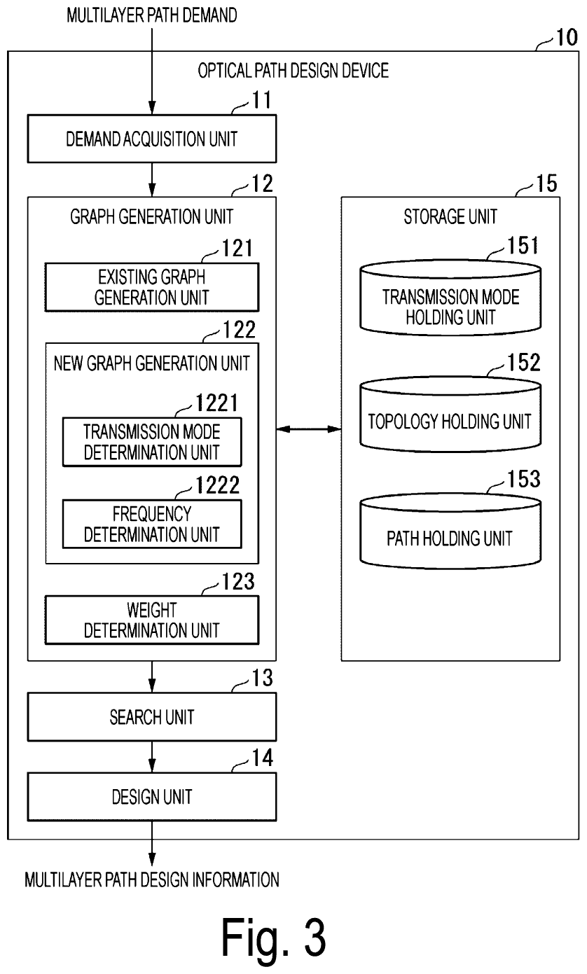

FIG. 3 is a schematic block diagram illustrating a configuration of an optical path design device 10 according to a first embodiment.

The optical path design device 10 includes a demand acquisition unit 11, a graph generation unit 12, a search unit 13, a design unit 14, and a storage unit 15.

The demand acquisition unit 11 acquires a multilayer path demand from a device connected with a multilayer network NW. The multilayer path demand is transferred by, for example, a node N connected with the device. The multilayer path demand includes a start point node, an end point node, and a required bit rate (required communication capacity).

The graph generation unit 12 generates an auxiliary graph including nodes N making up the multilayer network NW and an edge that is constructed between the nodes N and indicates a wavelength division multiplexing path satisfying the required bit rate of the multilayer path demand. The graph generation unit 12 includes an existing graph generation unit 121, a new graph generation unit 122, and a weight determination unit 123.

The existing graph generation unit 121 generates an existing graph in which a wavelength path to which a multilayer path demand can be additionally allocated among existing wavelength paths is set as an edge. The wavelength path to which the multilayer path demand can be additionally allocated is a wavelength path that has a sufficient space to satisfy the required bit rate of the multilayer path demand in the time slot.

The new graph generation unit 122 generates a new graph in which a candidate of a newly set wavelength path is set as an edge. The new graph generation unit 122 includes a transmission mode determination unit 1221 that determines a parameter such as a transmission mode or a frequency of a wavelength path candidate related to an edge of the new graph, and a frequency determination unit 1222 that allocates a frequency to the wavelength path candidate.

The weight determination unit 123 determines an edge weight of the auxiliary graph.

The search unit 13 searches for a route extending from a start point node to an end point node of the multilayer path demand.

The design unit 14 generates multilayer path design information including a setting instruction of a new wavelength path and an accommodation instruction for specifying a frequency and a time slot and accommodating a multilayer path demand on the basis of the searched route.

The storage unit 15 stores information necessary for generating the auxiliary graph. The storage unit 15 includes a storage area related to a transmission mode holding unit 151, a topology holding unit 152, and a path holding unit 153.

The transmission mode holding unit 151 stores a modulation scheme, a symbol rate, the number of necessary frequency slots (bandwidth), and the maximum hop count that can be transmitted in association with each other for each transmission mode. The maximum hop count is an example of a distance between nodes. Note that, in another embodiment, the transmission mode holding unit 151 may store another distance such as a path length in the physical topology instead of the maximum hop count. Moreover, as the frequency efficiency of the transmission mode becomes higher, the maximum hop count capable of transmission becomes smaller. The transmission mode holding unit 151 may store an available transmission mode for each node N.

The topology holding unit 152 holds information on a physical topology such as an optical transmission line or a node N making up the multilayer network NW. That is, the topology holding unit 152 holds information indicating a connection relationship between the nodes N.

The path holding unit 153 holds information on an existing multilayer path. For example, the path holding unit 153 holds a node N making up an existing wavelength path, a transmission mode, a frequency slot to be used, and a time slot being used for said wavelength path.

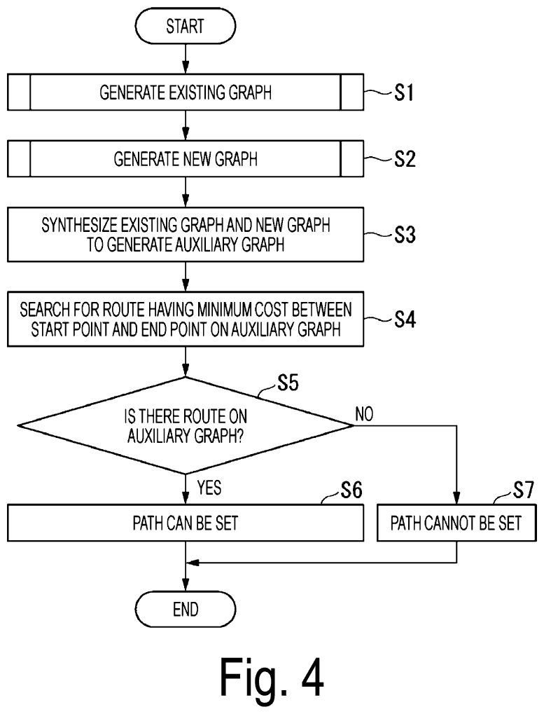

FIG. 4 is a flowchart illustrating a multilayer path design method according to the first embodiment.

When a multilayer path demand is inputted, the optical path design device 10 attempts to accommodate the multilayer path demand in the procedure illustrated in FIG. 4.

First, the existing graph generation unit 121 generates an existing graph indicating a wavelength path to which the required bit rate of the multilayer path demand can be allocated among the already allocated wavelength paths (step S1).

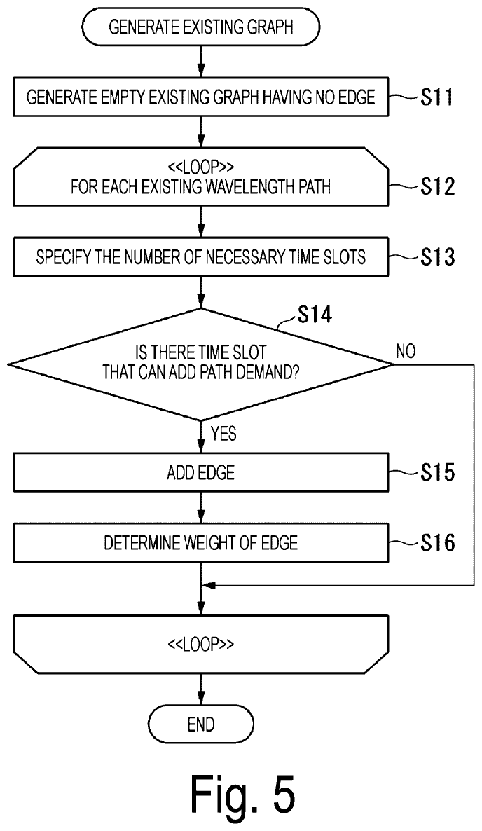

FIG. 5 is a flowchart illustrating a method of generating an existing graph according to the first embodiment.

The existing graph generation unit 121 first generates an existing graph of only a node N having no edge (step S11). Next, the existing graph generation unit 121 specifies all existing wavelength paths on the basis of the information held by the path holding unit 153, selects the existing wavelength paths one by one, and executes the following processing from step S13 to step S16 (step S12).

The existing graph generation unit 121 specifies the number of time slots necessary to satisfy the required bit rate on the basis of the transmission mode of the selected wavelength path (step S13). The existing graph generation unit 121 determines whether the specified number of time slots are empty or not in the selected wavelength path (step S14). In a case where the specified number of time slots are empty (step S14: YES), the existing graph generation unit 121 adds an edge connecting the start point and the end point of the selected wavelength path to the existing graph (step S15). The weight determination unit 123 determines the weight of the added edge according to the following Expression (1) (step S16).

$$\begin{matrix}[ Math . 1 ] & \\ {w}^{app} = {x}^{app} + {h}^{sd} * {y}^{app} & ( 1 )\end{matrix}$$

The symbol w^{app} denotes the weight of the edge of the existing graph. The symbol x^{app} denotes a constant term of the weight of the edge of the existing graph. The symbol h^{sd} denotes the hop count of the wavelength path. The symbol y^{app} denotes a coefficient of a weight for the hop count of the existing graph.

When the specified number of time slots are not empty in the selected wavelength path (step S14: NO), the next wavelength path is selected without adding an edge related to the wavelength path.

In this manner, the existing graph is created by the procedure illustrated in FIG. 5. In a case where there is a plurality of edges between a pair of the same nodes in the existing graph, the existing graph generation unit 121 may delete other edges while leaving only an edge having the smallest weight. Next, the new graph generation unit 122 generates a new graph indicating a wavelength path candidate to which the required bit rate of the multilayer path demand can be allocated (step S2).

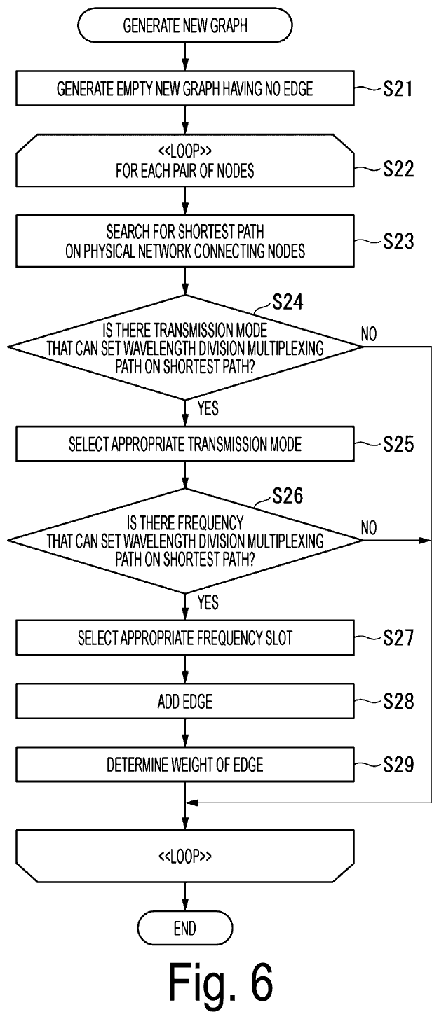

FIG. 6 is a flowchart illustrating a method of generating a new graph according to the first embodiment.

The new graph generation unit 122 first generates a new graph of only a node N having no edge (step S21). Next, the new graph generation unit 122 specifies all patterns of the pair of nodes N on the basis of information held by the topology holding unit 152, selects pairs of nodes N one by one, and executes the following processing from step S23 to step S26 (step S22).

The new graph generation unit 122 searches for the shortest path on the physical network connecting the selected pair of nodes N on the basis of information held by the topology holding unit 152 (step S23). Searching for the shortest path may be performed by a search algorithm such as the Dijkstra method or the A* method with the distance as the weight of the edge. The new graph generation unit 122 refers to the transmission mode holding unit 151 and determines whether there are one or more transmission modes that can be set for the wavelength path connecting the specified shortest path or not (step S24). That is, the new graph generation unit 122 determines whether there is a transmission mode having a maximum hop count that is equal to or larger than the hop count related to the shortest path or not.

In a case where there are one or more transmission modes that can be set (step S24: YES), the transmission mode determination unit 1221 of the new graph generation unit 122 selects an appropriate transmission mode from the one or more transmission modes that can be set on the basis of a predetermined policy (step S25). For example, the transmission mode determination unit 1221 may select a transmission mode having the smallest difference between the hop count of the path and the maximum hop count among one or more transmission modes that can be set, may select a transmission mode having the largest transmission capacity, or may select a transmission mode having the smallest necessary frequency band.

On the basis of information stored in the path holding unit 153, the new graph generation unit 122 determines whether there is an available frequency slot that can secure the frequency bandwidth required to set the selected transmission mode in the optical communication path connecting nodes related to the shortest path or not (step S26). The available frequency slot is a frequency slot that is not allocated to other wavelength paths. In a case where there is an available frequency slot (step S26: YES), the frequency determination unit 1222 of the new graph generation unit 122 selects an appropriate frequency slot from available frequency slots (step S27). For example, the frequency determination unit 1222 may select a frequency slot having the smallest frequency slot number among available frequency slots. Then, the new graph generation unit 122 adds an edge connecting the selected pair of nodes N to the new graph (step S28). The weight determination unit 123 determines the weight of the added edge according to the following Expression (2) (step S29).

$$\begin{matrix}[ Math . 2 ] & \\ {w}^{est} = {x}^{est} + {h}^{sd} * {y}^{est} & ( 2 )\end{matrix}$$

The symbol w^{est} denotes the weight of the edge of the new graph. The symbol x^{est} denotes a constant term of the weight of the edge of the new graph. The symbol y^{est} denotes a coefficient of a weight for the hop count of the new graph.

Note that, in a case where there is no transmission mode that can be set in the selected pair of nodes N (step S24: NO), or in a case where there is no available frequency slot (step S26: NO), a next pair of nodes N is selected without adding an edge connecting the pair of nodes N.

When a new graph is created by the procedure illustrated in FIG. 6, the graph generation unit 12 synthesizes the existing graph and the new graph to generate an auxiliary graph (step S3). In a case where there are a plurality of edges between a pair of the same nodes in the auxiliary graph, the graph generation unit 12 may delete other edges while leaving only an edge having the smallest weight. Next, the search unit 13 connects the node N at the start point and the node N at the end point of the multilayer path demand, and searches for a route having the smallest sum of weights on the auxiliary graph (step S4). Searching for a route may be performed by a search algorithm such as the Dijkstra method or the A* method with the distance as the weight of the edge. As a result of the search, the search unit 13 determines whether there is a route connecting the node N at the start point and the node N at the end point or not (step S5).

If there is a route (step S5: YES), the design unit 14 generates path design information for realizing the route (step S6). Specifically, the design unit 14 generates a setting instruction for newly setting a wavelength path on the basis of the path, the frequency slot, and the transmission mode set to the edge regarding the wavelength path candidate among edges on the searched route. Moreover, the design unit 14 generates an allocation instruction of a time slot that realizes the required bit rate for the wavelength path related to each edge on the searched route. The design unit 14 transmits the setting instruction and the allocation instruction to the corresponding node N.

In a case where there is no route (step S5: NO), the design unit 14 rejects the multilayer path demand since the multilayer path demand cannot be set (step S7). At this time, the design unit 14 may notify the transmission source of the multilayer path demand of the rejection.

Here, a multilayer path design method will be described using a specific example. In the following example, the following two transmission modes can be set as the transmission mode. In a transmission mode M1, the modulation scheme is 16 quadrature amplitude modulation (QAM), the bit rate is 200 Gbps, and the maximum hop count is 1. In a transmission mode M2, the modulation scheme is quadrature phase shift keying (QPSK), the bit rate is 100 Gbps, and the maximum hop count is 2.

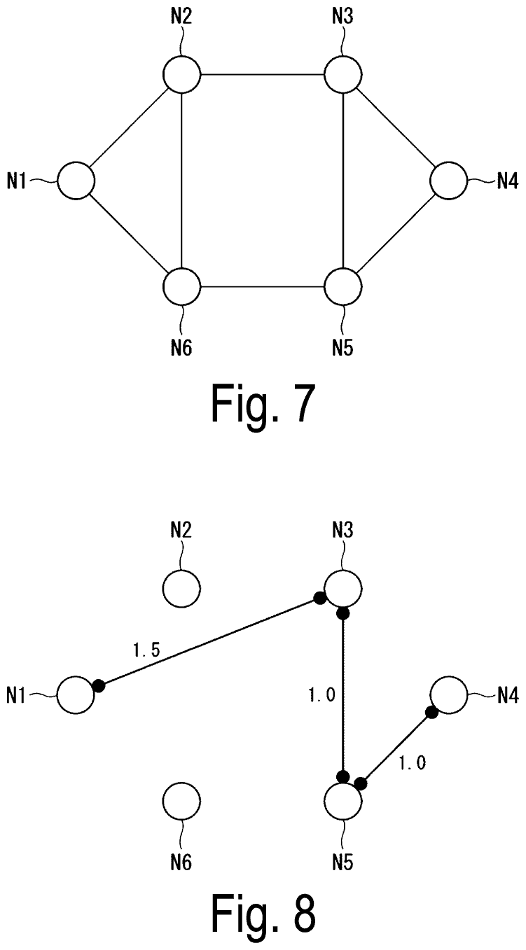

FIG. 7 is a diagram illustrating an example of a configuration of a physical network according to the first embodiment. As illustrated in FIG. 7, the multilayer network NW includes six nodes N, that is, a node N1, a node N2, a node N3, a node N4, a node N5, and a node N6.

The node N1 is physically connected with the node N2 and the node N6 by optical transmission lines.

The node N2 is physically connected with the node N1, the node N3, and the node N6 by optical transmission lines.

The node N3 is physically connected with the node N2, the node N4, and the node N5 by optical transmission lines.

The node N4 is physically connected with the node N3 and the node N5 by optical transmission lines.

The node N5 is physically connected with the node N3, the node N4, and the node N6 by optical transmission lines.

The node N6 is physically connected with the node N1, the node N2, and the node N5 by optical transmission lines.

It is assumed that a multilayer path demand between the node N1 and the node N4 is generated in such a multilayer network NW.

The existing graph generation unit 121 generates an existing graph. FIG. 8 is a diagram illustrating an example of an existing graph according to the first embodiment. In this example, it is assumed that there are existing wavelength paths each having a space in time slots between the node N1 and the node N3, between the node N3 and the node N5, and between the node N4 and the node N5, respectively. Note that the wavelength path between the node N1 and the node N3 is a two-hop path having the node N2 therein. In the example illustrated in FIG. 8, x^{app}=0.5 and y^{app}=0.5. As a result, the weight of the one-hop edge becomes 1.0, and the weight of the two-hop edge becomes 1.5.

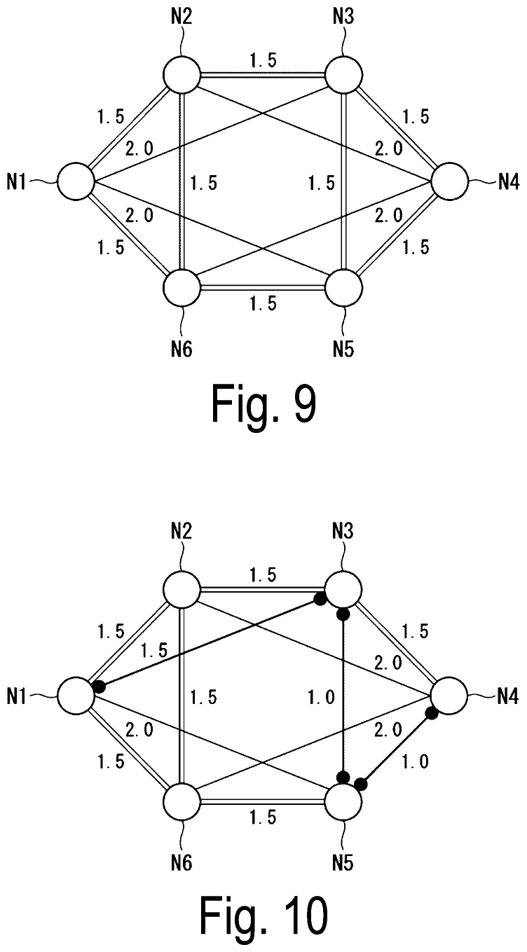

The new graph generation unit 122 generates a new graph. FIG. 9 is a diagram illustrating an example of a new graph according to the first embodiment. In this example, a one-hop edge is each provided between the node N1 and the node N2, between the node N2 and the node N3, between the node N3 and the node N4, between the node N4 and the node N5, between the node N5 and the node N6, between the node N1 and the node N6, between the node N2 and the node N6, and between the node N3 and the node N5, and a two-hop edge is each provided between the node N1 and the node N3, between the node N2 and the node N4, between the node N1 and the node N5, and between the node N4 and the node N6. The transmission mode determination unit 1221 of the new graph generation unit 122 determines the transmission mode on a bit rate priority basis. Therefore, the transmission mode 1 of 16 QAM is associated with a one-hop edge, and the transmission mode 2 of QPSK is associated with a two-hop edge. In the example illustrated in FIG. 9, x^{est}=1.0 and y^{est}=0.5. As a result, the weight of the one-hop edge becomes 1.5, and the weight of the two-hop edge becomes 2.0.

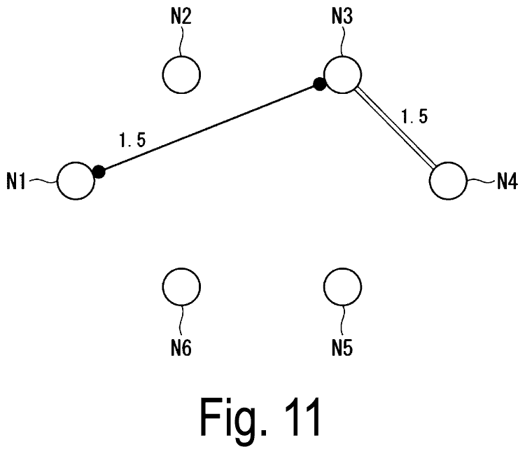

The graph generation unit 12 generates an auxiliary graph obtained by synthesizing the existing graph and the new graph. FIG. 10 is a diagram illustrating an example of an auxiliary graph according to the first embodiment. In a case where there are a plurality of edges in the same pair of nodes N, an edge having a smaller weight is selected. The search unit 13 calculates a route that accommodates the multilayer path demand. FIG. 11 is a diagram illustrating a route search result according to the first embodiment. As illustrated in FIG. 11, the search unit 13 detects a route passing through an edge between the node N1 and the node N3 and an edge between the node N3 and the node N4, where the sum of weights is smallest. As a result, the design unit 14 generates path design information for adding a time slot to the two-hop wavelength path between the node N1 and the node N3, and for newly installing the wavelength division multiplexing path of the transmission mode 2 between the node N3 and the node N4.

As described above, according to the first embodiment, the optical path design device 10 generates the auxiliary graph including the existing edge indicating the wavelength path to which the path demand can be allocated among the existing wavelength paths and the new edge indicating the wavelength path candidate satisfying the required bit rate related to the multilayer path demand. The optical path design device 10 sets the transmission mode and the frequency of the wavelength path, and the weight of the edge for each edge of the auxiliary graph. The optical path design device 10 generates path design information for setting a wavelength path for a new edge included in the route searched using the auxiliary graph, and for accommodating a multilayer path demand in a wavelength path related to each edge.

That is, by setting the transmission mode and the frequency for the new edge in the auxiliary graph, the optical path design device 10 can simultaneously determine the wavelength path to be newly set in order to accommodate the multilayer path demand and the transmission mode thereof.

Although one appropriate transmission mode is selected from the transmission modes that can be set in step S25 and an edge is added in the first embodiment, the present invention is not limited thereto. For example, in another embodiment, an edge weighted corresponding to the transmission mode may be added for each transmission mode. In this case, a weighting coefficient x^{est} or y^{est} may be set to, for example, a value corresponding to the frequency bandwidth or a value corresponding to the bit rate. Alternatively, the weight of the edge may be found by adding a value corresponding to the frequency bandwidth or a term corresponding to the bit rate to Expression (2).

Although an appropriate frequency slot is selected from a plurality of frequency slots and an edge is added in step S27 in the first embodiment, the present invention is not limited thereto. For example, in another embodiment, a weight corresponding to the center frequency may be found for a plurality of frequency bands, and an edge having the smallest weight may be added. In this case, the weight of the edge is found by adding a weight term corresponding to the center frequency to Expression (2). The weight corresponding to the center frequency may become smaller as the number of frequency slots becomes smaller, or may be smaller as the number of continuous empty frequency slots remaining after the addition of the wavelength path becomes larger.

Although the optical path design device 10 configures the existing graph and the new graph for all the nodes N in the network in the first embodiment, the present invention is not limited thereto. For example, in another embodiment, the calculation amount may be reduced by limiting the nodes N for which graphs are configured to some nodes. For example, in another embodiment, the optical path design device 10 calculates in advance a K-Shortest Paths algorithm for calculating K shortest paths between the start point and the end point of the multilayer path, and configures the existing graph and the new graph only for the sides included in the nodes N passing through there, so that the calculation amount can be reduced while nodes N necessary for calculating the optimal solution remain.

### Second Embodiment

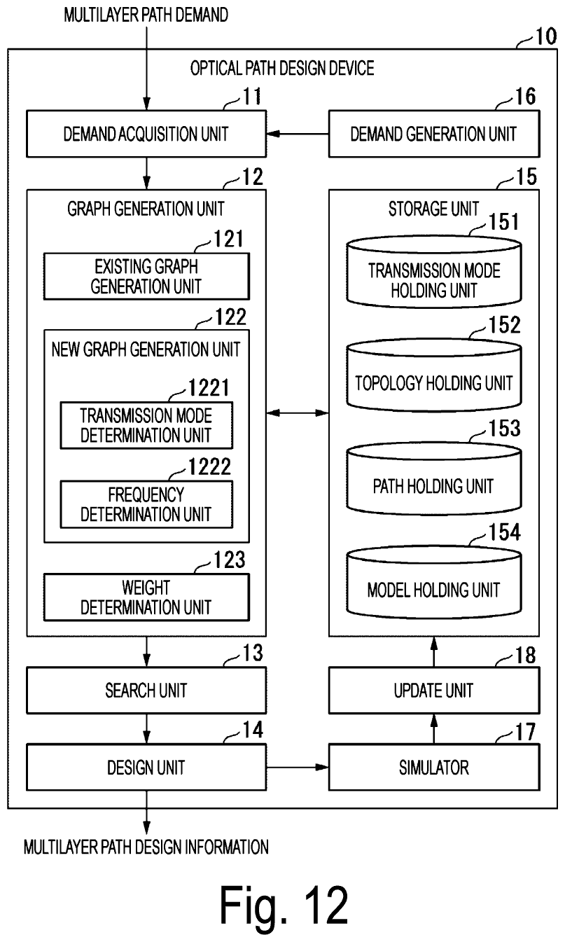

FIG. 12 is a schematic block diagram illustrating a configuration of an optical path design device 10 according to a second embodiment.

The optical path design device 10 according to the second embodiment determines the weight of an edge using a reinforcement learning model. That is, the optical path design device 10 according to the second embodiment is different from the first embodiment in processing of a weight determination unit 123. Moreover, a storage unit 15 according to the second embodiment further stores a model holding unit 154 that holds a learned model related to reinforcement learning.

A learned model held by the model holding unit 154 is a model learned to output x^{app}, y^{app}, x^{est}, and y^{est} when a feature amount vector representing an environment (a transmission mode, a frequency band, a time slot, and the like of an existing wavelength path) of the multilayer network NW is inputted.

The weight determination unit 123 calculates x^{app}, y^{app}, x^{est}, and y^{est} by inputting the state of the multilayer network NW at the time of generation of the multilayer path demand to the learned model. The weight determination unit 123 determines the weight of each edge by performing calculation of Expressions (1) and (2) using the calculated x^{app}, y^{app}, x^{est}, and y^{est}.

Note that the output of the learned model may be a probability density function for x^{app}, y^{app}, x^{est}, and y^{est}. In this case, the weight determination unit 123 may determine the weight of each edge using a peak value of the probability density function for each of x^{app}, y^{app}, x^{est}, and y^{est}.

Moreover, the optical path design device 10 according to the second embodiment further includes a demand generation unit 16, a simulator 17, and an update unit 18 in addition to the configuration of the first embodiment. The demand generation unit 16, the simulator 17, and the update unit 18 function as agents for reinforcement learning.

The simulator 17 simulates the behavior of the multilayer network NW. The simulator 17 simulates path design on the basis of path design information obtained by the design unit 14, and simulates communication based on a designed path.

The demand generation unit 16 generates a multilayer path demand to be simulated by the simulator 17. The demand generation unit 16 determines, for example, a start point node, an end point node, a required bit rate, and generation timing of the multilayer path demand on the basis of a random number.

The update unit 18 calculates a reward for the path design on the basis of the behavior of the simulator 17 after the path designed by the design unit 14 according to the multilayer path demand generated by the demand generation unit 16 is set, and updates parameters of the model held by the model holding unit 154 on the basis of the reward. The reward design can be arbitrarily set by the operator. For example, in a case where an objective function is designed to minimize the rejection rate of the multilayer path demand, the reward design can be set to +1 when the design is successful, and set to −1 when the design is rejected. The update unit 18 updates the parameters x^{app}, y^{app}, x^{est}, and y^{est} so that the reward for path design is maximized.

As described above, according to the second embodiment, the optical path design device 10 determines the weight of the edge using the reinforcement learning model. While the appropriate path design may change depending on the environment of the multilayer network NW, the optical path design device 10 according to the second embodiment can realize path design corresponding to the environment by appropriately changing the weight of the edge according to the environment.

Although the parameters x^{app}, y^{app}, x^{est}, and y^{est} are calculated using the learned model in the second embodiment, the present invention is not limited thereto. For example, in another embodiment, the learned model may be configured to output xᵢ^{est} and yᵢ^{est} for each transmission mode of the new path instead of common x^{est} and y^{est} regardless of the transmission mode. The suffix i denotes a transmission mode number.

In still other embodiments, the learned model may be configured to output a transmission mode to be set in addition to or instead of the parameters x^{app}, y^{app}, x^{est}, and y^{est}. In this case, the learned model may be configured to output the value of the reward for each transmission mode, and the transmission mode determination unit 1221 may select a transmission mode having the highest reward.

In still other embodiments, the learned model may be configured to output a frequency to be set in addition to or instead of the parameters x^{app}, y^{app}, x^{est}, and y^{est}. In this case, the learned model may be configured to output the value of the reward for each frequency slot, and the frequency determination unit 1222 may select a frequency band centered on a frequency slot having the highest reward.

Although the optical path design device 10 performs both the learning of parameters of the model and the calculation of the weight using the learned model in the second embodiment, the present invention is not limited thereto. For example, in another embodiment, a configuration for learning a parameter (e.g., the demand generation unit 16, the simulator 17, and the update unit 18) may be executed by a separate learning device, and the optical path design device 10 may calculate a weight using a learned model of a learning result obtained by the learning device.

### Other Embodiments

Although embodiments have been described in detail with reference to the drawings, specific configurations are not limited to the above-described configurations, and various design changes and the like can be made thereto. That is, in other embodiments, the order of the above-described processing may be changed as appropriate. Moreover, a part of the processing may be executed in parallel.

The optical path design device 10 according to the above-described embodiments may be configured with a single computer, or the configuration of the optical path design device 10 may be divided into a plurality of computers and the plurality of computers may function as the optical path design device 10 in cooperation with each other.

Moreover, although a node N according to the above-described embodiment determines the modulation scheme and the symbol rate by selecting the transmission mode, the present invention is not limited thereto. For example, a node N according to another embodiment may directly specify the modulation scheme and the symbol rate.

### <Computer Configuration>

The optical path design device 10 includes a processor, a memory, an auxiliary storage device, and the like connected by a bus, and functions as a device including the demand acquisition unit 11, the graph generation unit 12, the search unit 13, the design unit 14, and the storage unit 15 by executing an optical path design program. Examples of the processor include a central processing unit (CPU), a graphic processing unit (GPU), and a microprocessor.

The optical path design program may be recorded on a computer-readable recording medium. The computer-readable recording medium is a storage device such as a magnetic disk, a magneto-optical disk, an optical disk, or a semiconductor memory, for example. The optical path design program may be transmitted via a telecommunication line.

Note that all or some of the functions of the optical path design program may be implemented using a custom large scale integrated circuit (LSI) such as an application specific integrated circuit (ASIC) or a programmable logic device (PLD). Examples of the PLD include a programmable array logic (PAL), a generic array logic (GAL), a complex programmable logic device (CPLD), and a field programmable gate array (FPGA). Such an integrated circuit is also included in the examples of the processor.

### REFERENCE SIGNS LIST

10 Optical path design device
11 Demand acquisition unit
12 Graph generation unit
121 Existing graph generation unit
122 New graph generation unit
1221 Transmission mode determination unit
1222 Frequency determination unit
123 Weight determination unit
13 Search unit
14 Design unit
15 Storage unit
151 Transmission mode holding unit
152 Topology holding unit
153 Path holding unit
154 Model holding unit
16 Demand generation unit
17 Simulator
18 Update unit
N Node
NW Multilayer network

1. An optical path design device for designing a path on a basis of a path demand in an optical network including an optical communication path in which one or more time-divided wavelength paths are set, the optical path design device comprising:
a demand acquisition circuitry configured to acquire the path demand indicating a start point and an end point of communication and a required communication capacity;
a graph generation circuitry configured to generate an auxiliary graph, in which a plurality of nodes making up the optical network is connected by an existing edge that is an edge indicating a wavelength path to which the path demand can be allocated among wavelength paths set in the optical communication path and a new edge that is an edge indicating a candidate of a wavelength path that can be newly set, and in which a transmission scheme and a frequency of a wavelength path and a weight of the edge are set for each edge;
a search circuitry configured to search for a route from a start point to an end point indicated by the path demand for the auxiliary graph on a basis of the weight; and
a design circuitry configured to generate path design information for setting a wavelength path in the optical communication path by the transmission scheme related to the new edge included in the searched route, and for accommodating the path demand in the wavelength path at a frequency related to each edge included in the route.

2. The optical path design device according to claim 1,
wherein the graph generation circuitry sets at least one of the transmission scheme, the frequency, or the weight for each edge by reinforcement learning using a reward for allocation of the path demand based on a state of the optical network simulated by a simulator that simulates a state of the optical network after allocation of the path demand.

3. The optical path design device according to claim 1,
wherein the graph generation circuitry sets the weight of each edge on a basis of a distance of the wavelength path.

4. The optical path design device according to claim 1,
wherein the graph generation circuitry sets the transmission scheme of the new edge to a transmission scheme for which a difference between a transmission distance and a distance of a wavelength path related to the new edge is the smallest among a plurality of transmission schemes.

5. The optical path design device according to claim 1,
wherein the graph generation circuitry sets the weight on a basis of the transmission scheme or the frequency.

6. The optical path design device according to claim 5,
wherein the graph generation circuitry provides the new edge for each transmission scheme or each frequency, and
the search circuitry searches for a route including a combination of edges having a smallest weight.

7. An optical path design method for designing a path on a basis of a path demand in an optical network including an optical communication path in which one or more time-divided wavelength paths are set, the optical path design method comprising:
acquiring the path demand indicating a start point and an end point of communication and a required communication capacity;
generating an auxiliary graph, in which a plurality of nodes making up the optical network is connected by an existing edge that is an edge indicating a wavelength path to which the path demand can be allocated among wavelength paths set in the optical communication path and a new edge that is an edge indicating a candidate of a wavelength path that can be newly set, and in which a transmission scheme and a frequency of a wavelength path, and a weight of the edge are set for each edge;
searching for a route from a start point to an end point indicated by the path demand for the auxiliary graph on a basis of the weight; and
generating path design information for setting a wavelength path in the optical communication path by the transmission scheme related to the new edge included in the searched route and allocating the path demand to the wavelength path at a frequency related to each edge included in the route.

8. A non-transitory computer-readable storage medium storing a program for causing a computer to execute processes for designing a path on a basis of a path demand in an optical network including an optical communication path in which one or more time-divided wavelength paths are set, the processes comprising:
acquiring the path demand indicating a start point and an end point of communication and a required communication capacity;
generating an auxiliary graph, in which a plurality of nodes making up the optical network is connected by an existing edge that is an edge indicating a wavelength path to which the path demand can be allocated among wavelength paths set in the optical communication path and a new edge that is an edge indicating a candidate of a wavelength path that can be newly set, and in which a transmission scheme and a frequency of a wavelength path, and a weight of the edge are set for each edge;
searching for a route from a start point to an end point indicated by the path demand for the auxiliary graph on a basis of the weight; and
generating path design information for setting a wavelength path in the optical communication path by the transmission scheme related to the new edge included in the searched route, and for accommodating the path demand in the wavelength path at a frequency related to each edge included in the route.
